(19) United States
(12) Patent Application Publication
(10) Pub. No.: US 2023/0131527 A1
(43) Pub. Date: Apr. 27, 2023

(54) Security Printing

(71) Applicants: Keeling & Walker, Limited, Stoke-on-Trent (GB); Inovink Limited, Sheffield (GB)

(72) Inventors: Anna DOBROWOLSKA, Stoke-on-Trent (GB); Aimee JACKSON, Stoke-on-Trent (GB); David BEDFORD, Sheffield (GB); Angus WARD, Sheffield (GB)

(21) Appl. No.: 18/048,570

(22) Filed: Oct. 21, 2022

(30) Foreign Application Priority Data
Oct. 22, 2021 (GB) 2115235.0

(51) Int. Cl. B42D 25/415; B42D 25/29; B42D 25/23; B42D 25/26; B42D 25/21; B42D 25/382; B41M 3/14

(52) U.S. Cl. CPC B42D 25/415; B41M 3/14; B42D 25/21; B42D 25/23; B42D 25/26; B42D 25/29; B42D 25/382

(57) ABSTRACT

The use of a modified reduced indium tin oxide to provide a security image wherein the modified reduced indium tin oxide is obtained by heating indium tin oxide in a reducing atmosphere at a temperature of from 300 to 500° C.; and contacting the reduced indium tin oxide with an organophosphorus compound.

The present invention relates to articles comprising a security feature and to compositions and methods relating thereto. In particular the invention relates to articles comprising a security image, especially banknotes

Articles comprising security images are well known. Security images generally comprise an image which is invisible or undetectable under ambient conditions, and which can be rendered visible or detectable by application of a suitable stimulus; or alternatively, the image may change from one colour under ambient conditions to another colour upon application of a stimulus.

Security images may be manufactured by coating or printing security inks or compounds onto a substrate. Examples of known compounds which when coated onto a substrate provide a security image include photochromic compounds which generally change from colourless to coloured upon the application of ultraviolet light, and thermochromic compounds which generally change from colourless to coloured upon the application of heat. The present invention relates to the use of infrared absorbing compounds which can be detected by the application of infrared light.

In the manufacture of bank notes, it is desirable to include as many security features as possible, which may include multiple security images using a variety of compounds capable of changing colour upon application of a stimulus (including movement of the bank note to change viewing angle), or turning coloured from colourless, or vice versa.

The present invention relates in particular to security images which are visible upon application of infrared light. Such images are suitably not visible under ambient conditions but become visible when infrared light is applied.

The use of infrared absorbing materials as security features on articles is known. The presence of the infrared material can be verified using detection apparatus which emits light at a particular wavelength. A number of different types of detection apparatus are known. For example handheld devices used by individuals or small businesses may be quite different to apparatus used in banks or sorting offices and different again to detectors used in vending machines and the like.

It is desirable to include security features that can be detected by different types of apparatus and to include security features that can be detected at different wavelengths.

Counterfeiting is a serious problem across many sectors and, due to improvements in technology, counterfeiters are becoming increasingly sophisticated. In terms of infrared security images, it is desirable to provide an image which has a highly unique infrared spectrum that is difficult to reproduce.

Security features used on banknotes and the like need to be heat and UV resistant, water resistant, chemically resistant, and have excellent photostability.

It is also highly desirable that a security image does not significantly affect the colour of the substrate on which it is applied. This means that the presence of the security image is more difficult to detect. One material known to have properties which make it suitable for use as a security feature on banknotes is reduced indium tin oxide.

Indium oxide doped with 1 to 20 mol% tin has a strong absorption in the infrared region of the electromagnetic spectrum. The material is heat and UV resistant, photostable and water and chemical resistant.

The present inventors have now surprisingly found a method of processing this material so that it can be used to provide security images having a much lighter colour.

According to a first aspect of the present invention there is provided the use of a modified reduced indium tin oxide to provide a security image wherein the modified reduced indium tin oxide is obtained by heating indium tin oxide in a reducing atmosphere at a temperature of from 300 to 500° C.; and contacting the reduced indium tin oxide with an organophosphorus compound.

The present invention relates to a modified reduced indium tin oxide which is prepared from an indium tin oxide.

The material is a doped indium oxide and is based on indium oxide in which some of the indium atoms have been replaced by tin as a dopant element.

Suitably at least 0.1 mol% of the indium atoms have been replaced by tin.

Suitably up to 50 mol% of the indium atoms may be replaced by tin, for example up to 40 mol % or up to 30 mol%.

Preferably, the tin is present in an amount of from 1 to 20 mol%, preferably from 2 to 18 mol%, more preferably 5 to 15 mol%.

In one embodiment the doped indium oxide comprises 90% indium oxide and 10% tin oxide.

The present invention relates to the use of an indium tin oxide which has been heat treated in a reducing atmosphere.

Due to this treatment, the oxygen content of the lattice may be reduced by 0.1 to 10 wt%, for example by 0.5 to 5 wt%. The reduction process may not only form oxygen deficiencies in the crystal lattice, but may also form nanoparticles and nanoalloys of tin and indium providing advantageous properties.

The modified reduced indium tin oxide used as a security feature in the present invention is obtained by first heating indium tin oxide in a reducing atmosphere at temperatures of from 300 to 500° C.

Reduced indium tin oxides are known in the art. However materials of the prior art are typically obtained by heating at higher temperatures, for example in excess of 550° C.

Indium tin oxide is a commercially available material and can be prepared by methods known in the art, for example as described in US2013/0187104, US2018/0271756, US8153098 and WO2010/003743.

The compounds having utility in the present invention are obtained by reducing this material.

Suitably the reduced indium tin oxide used in the present invention is obtained by heating indium tin oxide in a reducing atmosphere at a temperature of from 350 to 700° C., for example 400 to 500° C.

The reduced indium tin oxide useful in the present invention is obtained by heating indium tin oxide in a reducing atmosphere.

Suitably the reducing atmosphere comprises a gaseous composition comprising one or more reducing agents.

Any suitable reducing agents may be used. Suitable reducing agents include carbon monoxide, hydrogen, alcohols (for example isopropanol) and acids (for example citric acid and oxalic acid).

Suitably the reducing atmosphere comprises an inert gas, for example nitrogen or argon and one or more reducing agents. The reducing agents are suitably present in an amount of from 1 to 50 vol%, suitably 0.1 to 30 vol%, preferably 1 to 20 vol%, more preferably from 2 to 10 vol %, for example about 5 vol%.

In preferred embodiments the reducing atmosphere comprises nitrogen and up to 10 vol% of a reducing agent, preferably selected from hydrogen, carbon monoxide and isopropanol.

When a liquid or solid reducing agent is used, for example isopropanol or citric acid, this may be pre-mixed with the indium tin oxide prior to heating.

For example an aqueous slurry of indium tin oxide and the reducing agent may be prepared. This slurry is then suitably heated in an inert atmosphere at a temperature of 300 to 500° C.

In one embodiment, 1 part indium tin oxide (by weight) is mixed with 0.1 to 10 parts, preferably 0.1 to 2 parts, more preferably 0.1 to 1 part (by weight), for example 0.2 to 0.8 parts of a mixture comprising from 10 to 90 vol% water and 90 to 10% isopropanol, preferably from 50 to 75% water and 25 to 50 vol% isopropanol.

When a gaseous reducing agent is used, for example hydrogen or carbon monoxide, this may be mixed with an inert gas, for example nitrogen or carbon dioxide and the indium tin oxide is heated to 300 to 500° C. in this gaseous mixture.

In one embodiment a gaseous reducing mixture comprising hydrogen and nitrogen is used.

In one embodiment a gaseous reducing mixture comprising carbon monoxide and carbon dioxide is used.

Suitably the reducing mixture may comprise from 0.1 to 50%, preferably 1 to 10% carbon monoxide and/or hydrogen and 50 to 99.9%, preferably 90 to 99% nitrogen and/or argon.

In one embodiment the reducing mixture comprises a mixture of 95 vol% nitrogen and 5 vol% hydrogen.

The reduced indium tin oxide is contacted with an organophosphorus compound.

Any organophosphorus compound can be used. By organophosphorus compound we mean a compound which includes a phosphorus atom and a hydrocarbyl group in which a carbon atom is bonded either directly or via an oxygen atom to the phosphorus atom.

Suitable organophosphorus compounds include hydrocarbyl phosphines, phosphate and phosphonate esters.

Preferred organophosphorus compounds are compounds of formula (II):

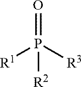

in which each of R1, R² and R³ is independently selected from OH, H, OR⁴, alkyl, aryl and (OR⁵)ₙOH; wherein R⁴ is alkyl or aryl; each R⁵ is independently ethyl or propyl; and n is at least 1.

Preferably each of R¹, R² and R³ is independently selected from OH, OR⁴, alkyl and aryl.

Preferably R¹ is OH, R² is OH and R³ is a group R wherein R is an optionally substituted hydrocarbyl group.

Preferably R is an optionally substituted alkyl, alkenyl, aryl, aralkyl, alkaryl group or an alkoxy containing group.

Preferably R is an unsubstituted alkyl, alkenyl, aryl, aralkyl or alkaryl group or an alkoxy containing group. Preferably R is selected from alkyl groups, aryl groups, aralkyl groups and alkoxy or phenoxy containing groups.

Suitable alkoxy containing groups include alkoxylated alkyl groups, polyalkoxylated alkyl groups, alkoxylated alcohols and polyalkoxylated alcohols.

Preferred alkoxy containing groups are polyalkoxylated alcohols especially moieties derived from ethylene oxide and/or propylene oxide. Especially preferred alkoxy containing groups are polyethylene glycol (PEG) or polypropylene glycol (PPG) groups having a number average molecular weight from 50 to 2500, more preferably from 50 to 1000, most preferably from 50 to 400.

In some embodiments R is an aryl group. Suitable aryl groups may comprise one or more aromatic rings. In some embodiments R may be naphthyl.

Suitable aryl groups include heterocyclic aryl groups. Preferred aryl groups have 5 to 7 carbon atoms and optionally contain one or more heteroatoms for example N, S or O.

Preferred aryl groups are phenyl and substituted phenyl groups.

In some embodiments R may be OAr where Ar is an aryl group. For example R may be phenoxy.

Suitable substituents include one or more alkyl and/or alkoxy containing groups. Preferred substituents include methyl, ethyl, propyl, butyl, pentyl, hexyl, heptyl, octyl, nonayl, and isomers thereof; derivatives of poly(isoprene) and poly(isobutylene) and polyalkoxylated alcohols especially moieties derived from ethylene oxide and/or propylene oxide. Some preferred substituents when R is phenyl are isohexyl, isoheptyl and isononyl.

In some embodiments R may be toluol or xylol.

In some embodiments R is an unsubstituted aryl group. In one preferred embodiment R is phenyl.

In some embodiments R is an optionally substituted alkyl group.

Suitable substituents include halo, hydroxy, nitro, amino and alkoxy.

Preferred alkyl groups are unsubstituted.

Suitably R is an unsubstituted linear or branched alkyl group.

Suitably R is selected from an alkoxy group, a phenoxy group or an alkyl or aryl group having 1 to 36 carbon atoms.

Preferably R is an alkyl or aryl group having 1 to 36 carbon atoms, preferably 2 to 30 carbon atoms, more preferably 4 to 24 carbon atoms, suitably 6 to 20 carbon atoms.

In some embodiments R is an unsubstituted alkyl or aryl group having 4 to 24 carbon atoms.

In some embodiments R is an unsubstituted alkyl group having 8 to 18 carbon atoms.

In one preferred embodiment R is C₈H₁₇.

In one preferred embodiment R is C₁₈H₃₇.

Most preferably R is selected from octyl, octadecyl and phenyl.

Most preferably R¹ is OH, R² is OH and R³ is selected from C₈H₁₇, C₁₈H₃₇ and phenyl.

Preferred organophosphorus compounds for use herein include octyl phosphonic acid, methylphosphonic acid dimethylester, tristearylphosphate, phenyl phosphate and triphenyl phosphate and polyethylene glycol monooleyl ether phosphate.

Without being bound by theory it is believed that the organophosphorus compound interacts with the surface of particles of the reduced indium tin oxide. The interaction may involve the formation of a covalent and/or an ionic bond. The interaction may be a non-covalent or nonionic interaction for example due to inter-molecular forces such as dipole interactions or Van der Waals forces.

In some embodiments the organophosphorus material may form a coating on the surface of the reduced indium tin oxide particles. The reduced indium tin oxide which is contacted with the organophosphorus compound is preferably in particulate form.

In some embodiments the particles of reduced indium tin oxide contacted with the organophosphorus compound have an average particle size of 1 to 100 microns, for example 10 to 50 or 20 to 30 microns.

In some embodiments the particles of reduced indium tin oxide contacted with the organophosphorus compound are nanoparticles.

Nanoparticles are suitably particles which have one or more dimensions of the order of 100 nm or less. Particle size may be measured by any suitable method. For example, any of the methods described in PAS 71:2005 published by British Standards could be used. Preferred methods for the determination of particle size include TEM (Transmission Electron Microscopy, when particles are made of a material that has high contrast with a carbon TEM grid), SEM (Scanning Electron Microscopy) and AFM (Atomic Force Microscopy). If the particles show plasmon resonance then the size can also be determined from the peak in the UV-VIS spectrum. For larger particles having a size of order of magnitude of 10⁻⁸ m or greater, light scattering can be used.

Primary particle size can be determined from peak broadness in an Xray diffraction spectrum. In a liquid phase particle size can be measured using dynamic light scattering.

Suitably the reduced indium tin oxide compound is contacted with from 0.001 to 50 wt%, preferably from 0.5 to 10 wt% of the organophosphorus compound.

The first aspect of the present invention provides the use of a modified reduced indium tin oxide to provide a security image.

Suitably the security image is visible upon application of infrared light.

Suitably the present invention provides the use of a modified reduced indium tin oxide as defined in relation to the first aspect as an infrared absorbing security image.

Suitably the security image is provided on an article. Detection of the security image may be used to determine whether an article is genuine.

According to a second aspect of the present invention there is provided an article comprising a substrate which carries a modified reduced indium tin oxide on a surface thereof, wherein the modified reduced indium tin oxide is obtained by heating indium tin oxide in a reducing atmosphere at a temperature of from 300 to 500° C.; and contacting the reduced indium tin oxide with an organophosphorus compound.

Preferably the article is a banknote.

The substrate may be coated or printed with a composition comprising the modified reduced indium tin oxide. The modified reduced indium tin oxide may be provided in a coating across one or more surfaces of the substrate.

Preferably the modified reduced indium tin oxide is used to provide a security image on a surface of the substrate.

The composition coated or printed onto the article may be provided in any suitable form. For example it may be provided in the form of an ink, a varnish or as a polymeric composition or polymer precursor composition.

In some embodiments the composition may comprise a polymer melt or pellets of polymer.

In some embodiments the composition may comprise a polymer precursor composition for example a composition comprising monomers which may be activated to undergo a polymerisation reaction.

The present invention may thus provide a polymer composition and/or a polymer precursor composition comprising particles of a modified reduced indium tin oxide wherein the modified reduced indium tin oxide is obtained by heating indium tin oxide in a reducing atmosphere at a temperature of from 300 to 500° C.; and contacting the reduced indium tin oxide with an organophosphorus compound

Such a polymer and/or polymer precursor composition could be used to provide a coating across an entire surface of a security article such as a banknote.

In especially preferred embodiments the composition coated or printed onto the article is an ink composition.

According to a third aspect of the present invention there is provided an ink composition having dispersed therein particles of a modified reduced indium tin oxide wherein the modified reduced indium tin oxide is obtained by heating indium tin oxide in a reducing atmosphere at a temperature of from 300 to 500° C.; and contacting the reduced indium tin oxide with an organophosphorus compound.

Preferred features of the third aspect are as defined in relation to the first and second aspects.

The ink composition is suitably a solution or suspension comprising the reduced indium tin oxide.

The modified reduced indium oxide may be suitably incorporated into the ink composition in the form of a powder. In some preferred embodiments the powder has an average particle size of less than 1 micron.

In some embodiments the modified reduced indium oxide is provided as nanoparticles. However microparticles may also be used.

In some embodiments the ink composition may be an aqueous composition. In some embodiments the ink composition may be an oleophilic composition. In some embodiments the ink composition may be a solvent based composition.

The selection of an aqueous based ink composition or an oleophilic based ink composition depends on how the ink is intended to be applied to the substrate. The choice of a suitable base ink composition will be within the competence of the person skilled in the art.

The base ink composition may be suitable for any type of printing, for example offset printing (lithographic), gravure printing, intaglio printing, letter-press printing, ink-jet printing and screen printing.

Aqueous ink compositions are typically used in screen printing and inkjet printing.

Oleophilic compositions are preferred for offset printing (lithographic), gravure printing, intaglio printing and letter press printing. They can also be used in inkjet printing.

In inkjet printing the ink composition may have an organic solvent base. Suitable organic solvents include acetone and other ketones, for example methyl ethyl ketone.

For some applications monomer based inks may be used, for example acrylic inks.

Rubber based inks may be used in lithographic, offset, letterpress and screen printing.

In preferred embodiments the ink composition is an oleophilic composition.

When the composition is an oleophilic composition the major component of the ink may be an oil, for example linseed oil. Other components typically present in printing inks will be known to the person skilled in the art.

The modified reduced indium tin oxide is preferably present in the ink composition in an amount of at least 0.1 wt%, preferably at least 1 wt.

The modified reduced indium tin oxide may be present in a composition in an amount of up to 50 wt%, suitably up to 40 wt%, for example up to 30 wt%, up to 20 wt%, or up to 10 wt%.

Most preferably the modified reduced indium tin oxide is present in the ink composition in an amount of from 3 to 5 wt%.

The amounts of modified reduced indium tin oxide present in the composition thereof varies depending on the intended use thereof and the nature of the ink composition. For example greater concentrations are typically used in offset printing inks compared with intaglio printing inks.

The ink composition may comprise one or more further components for example varnishes, cosolvents, preservatives, drying agents, fragrances, thickeners, waxes and emulsifiers. Other suitable components will be known to the person skilled in the art.

In some embodiments the ink composition may comprise one or more further pigments and/or dyes.

In some embodiments there may be no further pigments or dyes present in the ink composition.

A particular advantage of some embodiments of the present invention is that the modified reduced indium tin oxide has improved dispersibility in ink compositions compared with unmodified compounds of the prior art. This means fewer processing steps such as milling are needed, reducing the associated costs and energy consumption.

The ink composition of the third aspect is suitably coated or printed onto a substrate to provide a security image on an article.

The article may be selected from packaging, for example for pharmaceuticals; a label, for example for expensive or designer goods; an identification document, for example a passport, ID card or driving licence; a credit card or other bank card; a ticket or voucher, for example for events or travel; or a certificate, for example a share certificate or stamp certificate.

Most preferably the article is a banknote.

The article, especially when a banknote, may include one or more further security features, for example a UV image/phosphor, an NIR-absorbing image, a holographic feature, a watermark, a thread, a magnetic image, windows, a colour shift/colour change image or a microprinting feature. Further features will also be known to the person skilled in the art.

The article comprises a substrate. Preferably the substrate is a sheet substrate, preferably a planar sheet substrate. The substrate may be made from any suitable material. Suitable materials will be known to the person skilled in the art and include for example paper, cardboard, textiles and plastics materials.

In preferred embodiments in which the article is a banknote the substrate is selected from paper, a polymer or a mixture thereof. A preferred paper is banknote paper and a preferred polymer is biaxially oriented polypropylene. Other suitable papers and polymers will be known to the person skilled in the art.

Suitably modified reduced indium tin oxide is used to provide a security image on the surface of the substrate. The image may be present as a coating or a printed image. Suitably the security image is printed onto the substrate.

According to a fourth aspect of the present invention there is provided a method of manufacturing an article, the method comprising providing a substrate; and applying an ink composition of the third aspect onto a surface of the substrate.

The method of the fourth aspect may suitably involve the steps of:
(i) heating indium tin oxide in a reducing atmosphere at a temperature of 300 to 500° C.;
(ii) contacting the reduced indium tin oxide obtained in step (i) with an organophosphorus compound;
(iii) incorporating the modified reduced indium tin oxide obtained in step (iii) into an ink composition; and
(iv) applying the ink composition obtained in step (iii) onto a surface of a substrate.

Preferred features of the fourth aspect are as defined in relation to the first, second and third aspects.

In preferred embodiments the substrate is a planar substrate, preferably a banknote. The method may involve applying the ink composition to one or both surfaces of the substrate.

The method may comprise coating, spraying, dipping, painting or printing the ink composition onto a surface of the substrate.

In some preferred embodiments the method comprises printing an ink composition onto a surface of the substrate.

Any suitable printing technique may be used, for example offset printing (lithographic), gravure printing, intaglio printing, letter-press printing, ink-jet printing and screen printing. Preferably the composition is printed by intaglio printing.

Suitably the ink composition is coated or printed onto the substrate at a thickness of at least 1 micron. The thickness will depend on the printing technique used. For offset printing a thickness of 1 to 2 microns is typically used; for a varnish coating or gravure printing a thickness of 2 to 4 microns is preferred; and for intaglio printing a thickness of at least 5 microns, suitably about 8 microns and up to 40 or even up to 80 microns may be used.

The ink composition may be coated or printed onto one or both sides of the substrate.

In some embodiments the ink composition may be provided as an overcoat varnish.

Th ink composition is suitably printed onto a surface of the substrate to provide a security image.

The article of the second aspect suitably comprises a printed security image.

The security image comprises a modified reduced indium tin oxide which is obtained by heating indium tin oxide in a reducing atmosphere at a temperature of from 300 to 500° C.

Suitably the locus of the surface of the article which carries the security image absorbs infrared radiation.

Suitably the locus of the article which carries the security image has an infrared absorbance of at least 30%, preferably at least 40%, more preferably at least 45% and most preferably at least 50%, of at least one wavelength of infrared radiation.

The locus of the article which carries the security image suitably has an absorbance of at least 30% preferably at least 40%, more preferably at least 50% of at least one wavelength in the range 1200 to 2500 nm.

The locus of the article which carries the security image suitably has an absorbance of at least 30% preferably at least 40%, more preferably at least 50% of at least one wavelength in the range 1200 to 2000 nm.

Suitably the presence of the security image comprising the modified reduced indium tin oxide on the surface of the substrate does not substantially alter the colour of the substrate in the visible range.

Suitably the difference in colour between the substrate with and without the security image comprising the reduced indium tin oxide (dE, also referred to as E, dE* and E*) is less than 4, preferably less than 2, more preferably less than 1. The skilled person will appreciate that a dE of less than 1 is generally considered to be imperceptible to the human eye.

Because the presence of the modified reduced indium tin oxide does not substantially affect the colour of the substrate it may be used to provide a hidden or covert security feature.

In some embodiments the substrate may be printed with two paired inks. Suitably in such embodiments a first portion of the substrate is printed with a first ink pair composition and a second portion of the substrate is coated with a second ink pair composition wherein the second ink pair composition has all of the same components as the first ink pair composition except that it further comprises the modified reduced indium tin oxide.

Thus the paired inks are suitably identical except for the inclusion of the first and second infrared absorbing materials.

Suitably the colour difference dE between the first portion of the substrate printed with the first ink pair composition of the paired inks and the second portion of the substrate printed with the second ink pair composition of the paired inks is less than 4, preferably the dE is less than 2, more preferably less than 1.

A particular advantage of the present invention is that the modified reduced indium tin oxide obtained by heating indium tin oxide in a reducing atmosphere at 300 to 500° C. is much lighter in colour than reduced indium tin oxides of the prior art which are prepared by heating at a higher temperature.

The colour of a material may be defined using the CIELAB colour space. The measurement L* of at least 50, preferably at least 55, more preferably at least 60 according to CIELAB colour space measurement.

Because the modified reduced indium tin oxide is light in colour it can be used to provide a covert security image or a hidden coating on a banknote.

This security image produces a distinctive and variable absorption in the infra-red region but low absorbance in the visible region of the electromagnetic spectrum.

Infra-red absorption properties of the security image enable it to be used in an authentication method.

According to a fifth aspect of the present invention there is provided a method of detecting a genuine article, said method comprising applying infrared radiation to the article and detecting absorption of said infrared radiation; wherein the article comprises a substrate which carries a modified reduced indium tin oxide on a surface thereof and wherein the modified reduced indium tin oxide is obtained by heating indium tin oxide in a reducing atmosphere at a temperature of from 300 to 500°C; and contacting the reduced indium tin oxide with an organophosphorus compound.

Preferred features of the fifth aspect are as defined in relation to the first, second, third and fourth aspects.

In the method of the fifth aspect, the infrared radiation may be applied and detected by any suitable means. Typically radiation is applied and the reflectance thereof is measured, thus allowing absorbance to be calculated. Preferably the method employs a reader device. The reader device may comprise an infrared emitter and an infrared detector.

Broadband infrared radiation may be applied using an InGaAs detector. Alternatively, radiation of a specific wavelength can be applied by an infrared laser device, for example a YAG laser which emits radiation at 1064 nm.

Infrared radiation can be emitted and reflectance detected, for example, by using a Shimadzu UV-3101 UV-VIS-NIR spectrophotometer incorporating a reflectance head.

The method may further comprise measuring the extent of the absorption of infrared radiation at a selected wavelength. Thus the percentage absorbance or reflectance can be measured.

The method may comprise detecting the absorption of infrared radiation at more than one selected wavelength, for example at two or more selected wavelengths. The method may comprise measuring the extent of the absorption at more than one selected wavelength. It may further comprise measuring the ratio of absorbance or reflectance at two or more selected wavelengths.

The method may comprise measuring the absorption of infrared radiation over a range of wavelengths. It may further comprise measuring the extent of absorption over a range of wavelengths.

The method may comprise measuring and recording the infrared spectrum over a wavelength range, for example over the range 250 to 2500 nm, preferably 800 to 1700 nm.

Thus the method of the present invention may in some embodiments permit a quick, non-quantitative determination of the presence or otherwise of an infrared-absorbing material, by quickly checking for broadband adsorption or absorption at specific wavelength.

Alternatively, the method may be used to measure quantitatively the extent of absorbance at a specific wavelength or across a broad range of wavelengths. The more accurately the infrared absorption spectrum of an article is measured, the more difficult it would be to counterfeit such an article.

A reader device could be built into a machine, for example a passport scanner, a chip-and-pin device, or an ATM. Alternatively a reader device could be supplied independently as a mobile device.

The method of the fifth aspect may be carried out periodically on randomly selected articles or it may be carried out routinely on every article. For example, a photosensitive diode could be included in a cash machine to measure the IR absorbance at a given wavelength of each banknote. Thus, a counterfeit banknote could be easily detected.

In some embodiments the method of the fifth aspect may involve measuring the absorbance of radiation at two or more wavelengths. The measurement of two or more absorbancies allows ratios to be calculated, providing a higher degree of certainty that an article is authentic.

The method may involve determining the relative absorption at two different wavelengths and comparing this with a standard. Such a method could be carried out on a large scale.

For example multiple banknotes per second can be passed through a detector and the relative absorption ratio compared with a standard in an automated process.

The authentication method of the invention may find utility in a number of applications. For example a handheld device able to authenticate a single banknote at a time could be provided for use by small traders; a countertop device capable of evaluating multiple banknotes in an automatic method could be provided for use in a bureau de change or a vending machine; a device which validates individual notes as they are dispensed in an ATM could be provided; or equipment able to rapidly authenticate large numbers of notes, for example high speed note sorting.

Preferably the article is a banknote. Preferably it has a coating comprising reduced indium tin oxide or is printed with an image comprising reduced indium tin oxide. Suitably the reduced indium tin oxide coating or image is durable to heat, light, water, chemicals and mechanical impact, abrasion and wear and tear. Suitably the coating or image is durable to laundering and to UV light from sunlight.

However all banknotes and other articles will become worn over time, and the quality of the infrared absorbing coating or image may deteriorate. As the absorption of the coating/image depends on the concentration of the reduced indium tin oxide this may change as a banknote is worn. Thus measurement of the absorption at a locus of the banknote or other article may provide an indication of the quality of the article. The present invention may therefore provide a screening method to detect inferior banknotes or other articles.

The present invention may therefore provide a method of assessing the quality of an article of the second aspect, the method comprising measuring at a locus of the article which carries the modified reduced indium tin oxide, the absorption A₁ of at least one wavelength of λ₁ of radiation in the infra-red range and comparing the absorption with a known standard.

In some embodiments the method may involve further measuring at the locus of the article which carries a coating or image of the reduced indium tin oxide the absorption A₂ of a second wavelength λ₂ of radiation in the infra-red range, calculating the ratio of A₁ to A₂ and comparing this with a known standard.

Such a method may be used to provide an automatic screening method. For example the infra-red absorption A₁ and A₂ of banknotes can be measured and compared with a standard in an automated system. Banknotes which conform closely with the standard ratio can be redistributed whereas those on which the image has deteriorated can be withdrawn from circulation.

### BRIEF DESCRIPTION OF THE DRAWINGS

FIG. 1 shows a graph of the reflectance of the compound of Example 9, intaglio printing ink mixed with the pigment of Example 4.

FIG. 2 shows a graph of the reflectance of the compounds of Examples 1 and 8.

The invention will now be further described with reference to the following non-limiting examples.

Examples 1 to 7 describe the preparation of modified reduced indium tin oxide materials of the invention.

Example 8 describes the synthesis of a reduced indium tin oxide according to the prior art.

In each case the colour and infrared absorbing properties of the materials obtained were measured using standard techniques.

### Example 1

100 g of yellow indium tin oxide prepared according to known methods was taken and fired in the tube furnace in forming gas (5%H2/95%N2) at a flow rate of 0.2-0.3L/min and 1 bar pressure from the cylinder. Temperature was 350° C. After 12 hours the gas supply was 20 switched to 100% N2 (with the same flow rate) whilst the kiln cooled overnight. The resulting powder was dispersed in 500 ml DI water under stirring. 5 gr of Butylphosphate were added to the dispersion. Stirring was continued for 1 hour and the dispersion was then dried at 120° C. overnight.

The resulting powder showed following properties:
L-value: 57,3
a-value: -6,5
b-value: –9,6
NIR Absorption at 1500 nm: 55 % at 5% level in Intaglio ink Print on banknote paper

### Example 2

Yellow indium tin oxide powder was mixed with around 50% of a 25% isopropanol solution i.e. 30 50 g of solution containing 12.5 g of isopropanol + 37.5 g water mixed with 100 g of powder to give damp slurry. This was fired in a nitrogen atmosphere at 300 to 500° C. for 4 to 5 hours. After cooling the resultant material was contacted with 5 gr Butylphosphate dissolved in 5 gr of Isopropanol. Following the homogenisation the powder was dried at 100° C. in air.

The resulting powder showed following properties:
L-value: 65
a-value: -5
b-value: –10
NIR Absorption at 1500 nm: 35 % at 5% level in Intaglio ink Print on banknote paper

### Example 3

Yellow indium tin oxide powder was mixed with around 50% of a 25% isopropanol solution i.e. 30 50 g of solution containing 12.5 g of isopropanol + 37.5 g water mixed with 100 g of powder to give damp slurry. The slurry was further treated with an 50% alcoholic solution of Trioctylphosphate. The resulting paste was fired in a nitrogen atmosphere at 300 to 500° C. for 4 to 5 hours. The product was milled to give a fine blue powder.

The resulting powder showed following properties:
L-value: 62
a-value: -5,1
b-value: –10,3
NIR Absorption at 1500 nm: 30 % at 5% level in Intaglio Ink Print on banknote paper

### Example 4

100 g of yellow indium tin oxide prepared according to known methods was taken and fired in the tube furnace in forming gas (5%H2/95%N2) at a flow rate of 0.2-0.3 L/min and 1 bar pressure from the cylinder. Temperature was 400° C. After 12 hours the gas supply was 20 switched to 100% N2 (with the same flow rate) whilst the kiln cooled overnight. The resulting powder was dispersed in 500 ml DI water under stirring. 10 gr of Octylphosphonic Acid were added to the dispersion. Stirring was continued for 1 hour and the dispersion was then dried at 120° C.

The resulting powder showed following properties:
L-value: 64
a-value: -5,1
b-value: –12,2
NIR Absorption at 1500 nm: 70 % at 1% level in Intaglio ink Print on banknote paper

### Example 5

100 g of yellow indium tin oxide prepared according to known methods was taken and fired in the tube furnace in forming gas (5%H2/95%N2) at a flow rate of 0.2-0.3 L/min and 1 bar pressure from the cylinder. Temperature was 350° C. After 12 hours the gas supply was 20 switched to 100% N2 (with the same flow rate) whilst the kiln cooled overnight. The resulting powder was dispersed in 500 ml DI water under stirring. 5 gr of Butylphosphate were added to the dispersion. Stirring was continued for 1 hour and the dispersion was then dried at 120° C.

The resulting powder showed following properties:
L-value: 64
a-value: -5,1
b-value: –12,2
NIR Absorption at 1500 nm: 55 % at 5% level in Intaglio Ink Print on banknote paper

### Example 6

100 g of yellow indium tin oxide prepared according to known methods was taken and fired in the tube furnace in forming gas (5%H2/95%N2) at a flow rate of 0.2-0.3 L/min and 1 bar pressure from the cylinder. Temperature was 400° C. After 12 hours the gas supply was 20 switched to 100% N2 (with the same flow rate) whilst the kiln cooled overnight. The resulting powder was dispersed in 500 ml DI water under stirring. 10 gr of a long chain, polyethoxylated octadecenol phosphate ester were added to the dispersion. Stirring was continued for 1 hour and the dispersion was then dried at 120° C.

The resulting powder showed following properties:
L-value: 60,3
a-value: -6,2
b-value: –11,6
NIR Absorption at 1500 nm: 60 % at 1% level in Intaglio ink Print on banknote paper

### Example 7

100 g of yellow indium tin oxide prepared according to known methods was taken and fired in the tube furnace in forming gas (5%H2/95%N2) at a flow rate of 0.2-0.3 L/min and 1 bar pressure from the cylinder. Temperature was 400° C. After 12 hours the gas supply was 20 switched to 100% N2 (with the same flow rate) whilst the kiln cooled overnight. The resulting powder was dispersed in 500 ml DI water under stirring. 5 gr of long chain, polyethoxylated octadecenol phosphate ester were added to the dispersion. Stirring was continued for 1 hour and the dispersion was then dried at 120° C.

The resulting powder showed following properties:
L-value: 62,1
a-value: -6,0
b-value: -10,6
NIR Absorption at 1500 nm: 65 % at 1% level in Intaglio ink Print on banknote paper

### Example 8 - Comparative

100 gr of yellow indium tin oxide prepared to known methods was taken and fired in a tube furnace in forming gas at a flow rate of 1 I/min. and 1 bar pressure. Temperature was 450° C. After 6 hours the gas supply was switched to Nitrogen and then the furnace was allowed to cool over night.

The resulting product was a fine dark-blue powder at a yield of 98%.

The colour analysis of the powder showed
L-value: 46,1
a-value: -3,75
b-value: -9,63
NIR Absorption at 1500 nm: 70% at 5% level in Intaglio Ink Print on banknote paper

### Example 9

99 gr of an intaglio printing ink were mixed with 1 wt% of the pigment of Example 4 in a speed mixer. The printing ink was printed on banknote paper strips with an Orange Test Printing Machine. The dried paper strips were then analysed with NIR spectrocospy and the colour of the prints were measured.

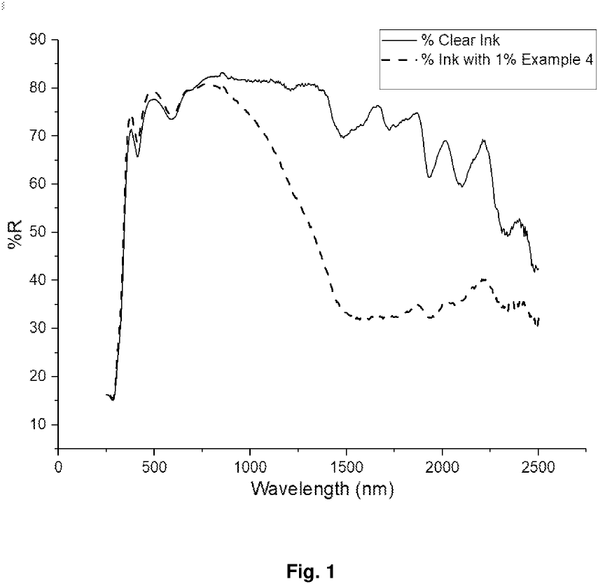

The results are shown in Table 1 and FIG. 1.

TABLE 1

| Sample | L | a | b |
|---|---|---|---|
| Clear Ink print | 89.71 | -2.01 | 1.25 |
| Example 4 1% print | 91.00 | -1.86 | -0.06 |

### Example 10

The visible and infrared spectra of powders prepared according to examples 1 and 8 were recorded, along with colour measurements.

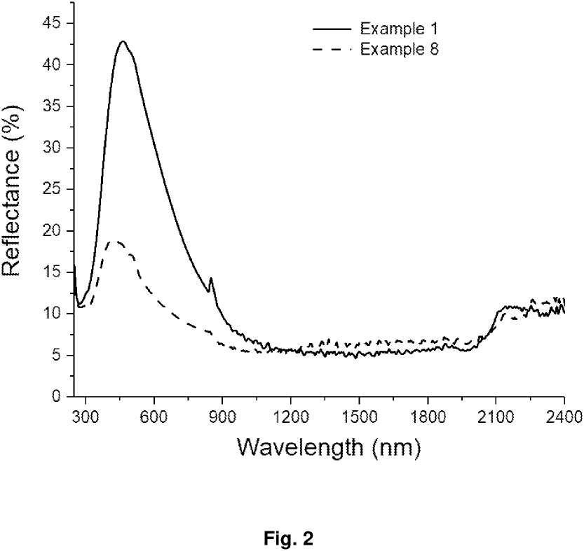

The results are shown in FIG. 2 and table 2.

TABLE 2

| Sample | L | a | b |
|---|---|---|---|
| Example 8 | 46.14 | -3.75 | -9.63 |
| Example 1 | 57.37 | -6.5 | -12.01 |

1. A method of producing a modified reduced indium tin oxide comprising: heating indium tin oxide in a reducing atmosphere at a temperature of from 300 to 500° C.; and contacting the reduced indium tin oxide with an organophosphorus compound.

2. The method of claim 1 wherein tin is present in the reduced indium tin oxide in an amount of from 5 to 15 mol%.

3. An article comprising a substrate which carries a modified reduced indium tin oxide prepared according to the method of claim 1 on a surface thereof.

4. The article according to claim 3 selected from a group consisting of: packaging; a label; an identification document; a credit card or other bank card; a ticket or voucher; and a certificate.

5. An article according to claim 3 which is a banknote.

6. An article according to claim 3,
wherein the reduced indium tin oxide forms a security image on the surface of the substrate.

7. A polymer composition or a polymer precursor composition comprising particles of a modified reduced indium tin oxide prepared according to the method of claim 1 .

8. An ink composition having dispersed therein particles of a modified reduced indium tin oxide prepared according to the method of claim 1.

9. A method of manufacturing an article, the method comprising providing a substrate; and applying an ink composition of claim 8 onto a surface of the substrate.

10. A method of manufacturing an article, the method comprising the steps of:
(i) heating indium tin oxide in a reducing atmosphere at a temperature of 300 to 500° C.;
(ii) contacting the reduced indium tin oxide obtained in step (i) with an organophosphorus compound;
(iii) incorporating the modified reduced indium tin oxide obtained in step (iii) into an ink composition; and
(iv) applying the ink composition obtained in step (iii) onto a surface of a substrate.

11. An article according to claim 3, wherein the difference in colour between the substrate with and without the security image comprising the reduced indium tin oxide (dE) is less than 2.

12. The method of claim 1,
wherein the colour of the reduced indium tin oxide is such that it has an L* measurement of at least 50.

13. A method of detecting a genuine article, said method comprising applying infrared radiation to the article and detecting absorption of said infrared radiation; wherein the article comprises a substrate which carries modified reduced indium tin oxide on a surface thereof and wherein the modified reduced indium tin oxide is obtained according to the method of claim 1.

14. A method of assessing the quality of an article of the second aspect, the method comprising measuring at a locus of the article which carries the modified reduced indium tin oxide, the absorption A₁ of at least one wavelength of λ₁ of radiation in the infra-red range and comparing the absorption with a known standard.
